(19) United States
(12) Patent Application Publication
(10) Pub. No.: US 2011/0225510 A1
(43) Pub. Date: Sep. 15, 2011

(54) System and method for social networking

(76) Inventors: Egor Lavrov, Miami, FL (US); Anton Zingarevich, St. Petersburg (RU); Gennadiy Zingarevich, St. Petersburg (RU)

(21) Appl. No.: 12/661,013

(22) Filed: Mar. 9, 2010

(51) Int. Cl. G06F 3/01; G06F 15/16

(52) U.S. Cl. 715/751

(57) ABSTRACT

A system of the present invention provides social networking between users subscribed to the system. A controller of the system includes a database of questions to be answered by users to create personality profile of the user. A program of the controller is adaptable to store predetermined identifiers with each of the identifiers representing a type of the personality of the user. A global positioning system is operably communicated with the controller to determine location of the user and present current location of the user through a computing device of the user.

### FIELD OF THE INVENTION

The present invention relates to system and method of social networking to allow people to identify each other based on common interests.

### BACKGROUND OF THE INVENTION

Today, social networking services play important part in day to day activities of people. These social networking services allow people to create and join social groups with common interests and activities. Most of the social networking services are web based, where users form virtual communities make friends, and look for other users with common interests, share information between each other, build up relationship, or simply use these social networking services for business purposes.

By the way of background, a first recognizable social network site, i.e. SixDegrees.com, was launched in 1997. This site allowed users to create profiles, list of friends and surf the “Friends lists”. Profiles existed on most major dating sites and many community sites. Later on, another website, called Classmates.com, came on the market thereby allowing people to affiliate with their high school or college and surf the network for others who were also affiliated, but users could not create profiles or list friends until years later.

From 1997 to 2001, a number of community tools began supporting various combinations of profiles and publicly articulated friends. AsianAvenue, BlackPlanet, and MiGente allowed users to create personal, professional, and dating profiles—users could identify Friends on their personal profiles without seeking approval for those connections

The art is replete with various other online social networking applications are known in the art. These applications are typically operated as managed services by application service providers (ASPs) and share several common characteristics. In particular, users typically create unique personal profiles that include basic information including identity, interests, profession, history, testimonials and information about their network. Users map their relationship with other members, either inviting other members to join their network (e.g., Friendster and Linkedln), or by using software to scan existing relationships recorded in computer contact software (e.g., Spoke and Visible Path). Typically, connections are initiated by sending messages (instant messages or emails) to friends who are already known or directly to people that are not known by the user. Other connections can be made through linking chains of existing relationships of people who may or may not be known to the user.

There are also mobile social networking applications known in the art. These applications provide such functions as friend-finding, text-dating and community message aggregation. Such applications may also consult the relationship map and identify “friends of friends” who have announced they are within a certain range of the user's vicinity.

Still another prior art application, such as text-dating applications (e.g., MobiVibe) allows users to connect with new friends who meet age and gender criteria, enabling the users to communicate with each other. Technologies such as RFID, GPS, and Bluetooth are used to identify individuals with related interests when they are in proximity to each other. If the individuals are sufficiently close to each other, various systems have been combined with profile records to determine if the individuals have interests that “match” and, if so, to facilitate the exchange of location information between the individuals.

The art is replete with various prior art references related to numerous systems and methods for social networking. These prior art references include and are not limited to U.S. Pat. Nos. 6,711,414 and 6,757,719 to Lightman et al., 6,977,612 to Bennet, 6,996,402 to Logan, 6,618,593 to Drutman, 6,419,217 and 6,758,397 to Catan, 7,098,793 and 6,961,000 both to Chung, 6,992,574 to Aupperle, et al., 7,092,002 to Ferren et al., and 7,609,167 to Light et al. and United States Patent Application Nos. 20050174975 filed by Mgrdechian, et al., 20070030824 filed by Ribaudo et al., 20060256959 filed by Hymes, 20070096909 filed by Lally, and 20080140650 filed by Stackpole.

The U.S. Pat. No. 7,609,167 to Light et al. This patents teaches a network wherein a subscriber's computer is associated with a subscriber identifier. A subscriber security profile is created in a security profile datastore, wherein the subscriber security profile comprises information indicative of a security status and wherein the subscriber security profile is associated with the subscriber's subscriber identifier. Subscriber identifiers associated with subscribers who are logged in to a website are monitored. The website defines a virtual space and the logged-in subscribers are characterized as present in the virtual space. A web page is served to the computing devices of the present subscribers via the network. An attribute is assigned to the icons of the other present subscribers having security profiles that match the security profile of the first subscriber according to security matching criteria. Selected security profile information is provided to the first subscriber of a selected one of any of the other present matching subscribers. This particular system prevents a person using his/her cell phone and without multiple steps of logging in to the system to identify a location within a proximity to the person wherein other people sharing the same background, interest, hobbies, etc. are located at the present time or visited the location or even are planning to visit location in the future.

The United States Patent Application No. 20080140650 filed by Stackpole discloses a method and system for establishing a geosocial network. As taught by this prior art reference, a client application is provided on a communications device of a user seeking to establish the geosocial network. The user creates a personal profile and a preference profile using the client application. The preference profile refers to characteristics the user seeks in potential members of the geosocial network. The user transfers the personal and preference profiles to the social networking server. The social networking server registers a location and range selected by the user for the geosocial network.

The social networking server of the United States Patent Application No. 20080140650 filed by Stackpole identifies potential members within the registered location and range by matching the personal profile of each of the potential members with the preference and personal profiles of the user. The social networking server provides communications link between the user and the identified potential members upon mutual confirmation between the user and the identified potential members. Similar to the system disclosed by the U.S. Pat. No. 7,609,167 to Light et al., the system disclosed by the United States Patent Application No. 20080140650 filed by Stackpole prevents a person using his/her cell phone and without multiple steps of logging in to the system to identify a location within a proximity to the person wherein other people sharing the same background, interest, hobbies, etc. are located at the present time or visited the location or even are planning to visit location in the future.

Hence, there is a need for an improved method and system for location based dynamic social networking whereby a person using his/her cell phone may instantly identify a location, so called “hot spot” within a proximity to the person wherein other people sharing the same background, interest, hobbies, etc. are located at the present time or visited the location or even are planning to visit location in the future.

### SUMMARY OF THE INVENTION

A system and method of the present invention provides a unique and useful tool to users/subscribers seeking to identify various venues such as shows, art galleries, restaurants, night clubs and any other venues where the users of similar type or interests have visited in the past or are currently visiting. The system of the present invention can be used on any type of communications devices including and not limited to mobile phones, laptops having interne connection without limiting the scope of the present invention, wherein the system may employ Global Positioning System (GPS) to generate the information regarding location located within pre-selected by the subscriber distance and range to be fed to the social networking server.

The process begins with registration of the user on a website of the system. The registration is not limited to the websites. The user may register through his/her mobile phone by sending a text message, for example. When the user is registered he/she will be asked a multitude of questions to determine the personality of the user, interests of the user, etc. Based on the user type, a color code will be assigned to the user. For example, the user will be assigned red color if he/she likes hard rock music, extreme sports, piercing. Green color will be assigned to the users people who like classical music, golf and reading books. Yellow color will be assigned to people who like pop music, baseball and movies. Mixed colors maybe used as well. Those skilled in the art will appreciate that the aforementioned color are used for exemplary purposes without limiting the scope of the present invention. Many other colors such as grey, orange, pink, etc. may be used in application of the present invention without limiting the scope of the present invention.

If, for example, the user likes both hard rock music, extreme sports along with classical music, golf and reading books, he/she will be assigned a combined color code that may be presented as a mixed color (combination of green and red). The software of the inventive system will be operatively communicated with Global Positioning System (GPS) and Google's map system or any other similar applications we will provide the users to virtually “check in” in any place in the city (restaurants, bars, shops, offices etc), depending to what type (color) of people, i.e. users go to certain places. The color of these places will change depending upon time of the day, events being held at these places, etc. For example, if today it's a rock band performance in American Airline Arena in Miami or at Times Square in New York—it probably will be shown as “red”, if it's a baseball event there—it's going to be yellow, if it's a classical even—the area will be “green”. If it's used as a hurricane shelter and all kind of people are in there—the place will be presented in shades/mix of all colors.

Places on the map and map itself will change it is colors dynamically. The system and method of the present invention provides the users with unique and easy way to find places that people that think alike or share the same interests are coming to or to find people like them, etc. The system will also identify certain venues on the map by a color. If the user likes classical music, golf and reading books then all venues such as golf courses, libraries, and concert halls will be displayed in green. The radius of the venues in its relation to the user can be expanded without limitations. The user will be able to view all venues within 10 or 30 miles from the place where the user is currently located. The user may touch on any location on his/her screen to receive information such as hours of operation of the venue, menu, and the price for a ticket to attend the venue.

When the user will register to use the inventive system, he/she will have an option to be viewable to other people who have the same interest and/or to view only places of interest, and or both. This feature will allow the user who does not want to keep his/her interest in confidence but at the same time wants to know about venues and activities of the kind to make a choice whether to attend the same or not.

Alluding to the above, the system is easy to be used. The user may be located anywhere in the world. If, for example, the user is located on Madison Avenue, New York, the user may activate the system on his/her mobile phone or any other suitable data communication device. The system will display all venues located within any pre-selected radius from the place where the user is located. The user, assuming the user's color is “red” will select an option to view all venues located on Madison Avenue and within the pre-selected radius therefrom, wherein all hard rock music, extreme sports, piercing events take place at a particular time or took place days ago in the past or will take place in the future.

An advantage of the present invention is to provide an improved method and system for location based dynamic social networking whereby a person using his/her cell phone may instantly identify a location, so called “hot spot” within a proximity to the person wherein other people sharing the same background, interest, hobbies, etc. are located at the present time or visited the location or even are planning to visit location in the future.

Another advantage of the present invention is to provide an improved system and method for social networking wherein the user may identify a venue visited by other user or personality types that is similar or substantially similar to the user's personality type simply by activating the system through the user's mobile phone at any given location where the user is present wherein the given location will be exposed to the user through colors wherein the user may identify other having the same “color” as the user.

Still another advantage of the present invention is to provide an improved system and method for social networking wherein the user may locate other users or personality types that is similar or substantially similar to the user's personality type right on a spot without utilizing prior art methods and techniques.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIGS. 1 and 2 illustrates a user completing a questionnaire provided by inventive system wherein a color associated with the user's personality is identified and assigned to the user;

FIG. 3 illustrates a front view of a screen of a cellular phone indicating a location of the user (show by a star) at a particular street and a plurality of various establishments along the street and at intersection of that street with other streets, wherein various sections of the location are presented in different colors wherein area of the street located on the left side relative the user is presented in colors similar to the color assigned to the user;

FIG. 4 illustrates the front view of the screen of the mobile phone shown in FIG. 4, wherein the area of the street located on the left side relative the user is presented in colors similar to the color assigned to the user is now enlarged to indicate three particular establishments and number of other users in each of the establishment having various “colors” based on their personality type;

FIG. 5 illustrates a perspective view of the street and a fragmental view of the user holding the mobile phone with the screen as illustrated in FIG. 3;

FIG. 6 illustrates a schematic view of the present invention;

FIG. 7 illustrates a diagram of various components of the inventive system operably communicating with one another to facilitate inventive method of identifying other users and locations by colors; and

FIG. 8 illustrates another diagram of alternative embodiment of the present invention with various components operably communicating with one another to facilitate inventive method of creating new identifiers and assigned new color codes thereby identifying other users and locations by color codes.

### DETAILED DESCRIPTION OF THE INVENTION

Referring to the Figures, wherein like numerals indicate like or corresponding parts throughout the several views, a system for providing social networking between users subscribing to the system from communication devices, such as, for example mobile or cellular phones is generally shown at 10.

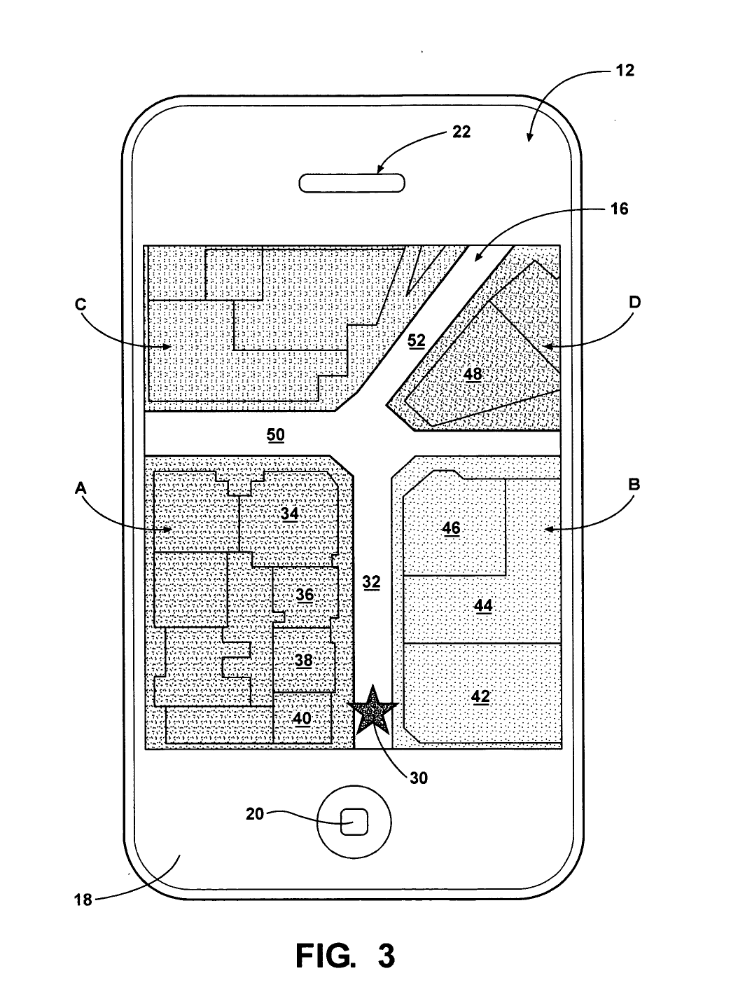

The system 10 and method of the present invention provides a unique and useful tool to users/subscribers seeking to identify various venues such as shows, art galleries, restaurants, night clubs and any other venues where the users of similar type or interests have visited in the past or are currently visiting. The system 10 of the present invention can be used on any type of communications devices including and not limited to cell or cellular phones 12, generally indicated at 12 in FIGS. 3 through 5, mobile phones, laptops having internet connection without limiting the scope of the present invention, wherein the system 10 may employ Global Positioning System (GPS) to generate the information regarding location located within selected by the subscriber 14 distance and range to be fed to the social networking server. The subscriber 14 may also be referred to as the user throughout the description of the inventive concept without limiting the scope of the present invention.

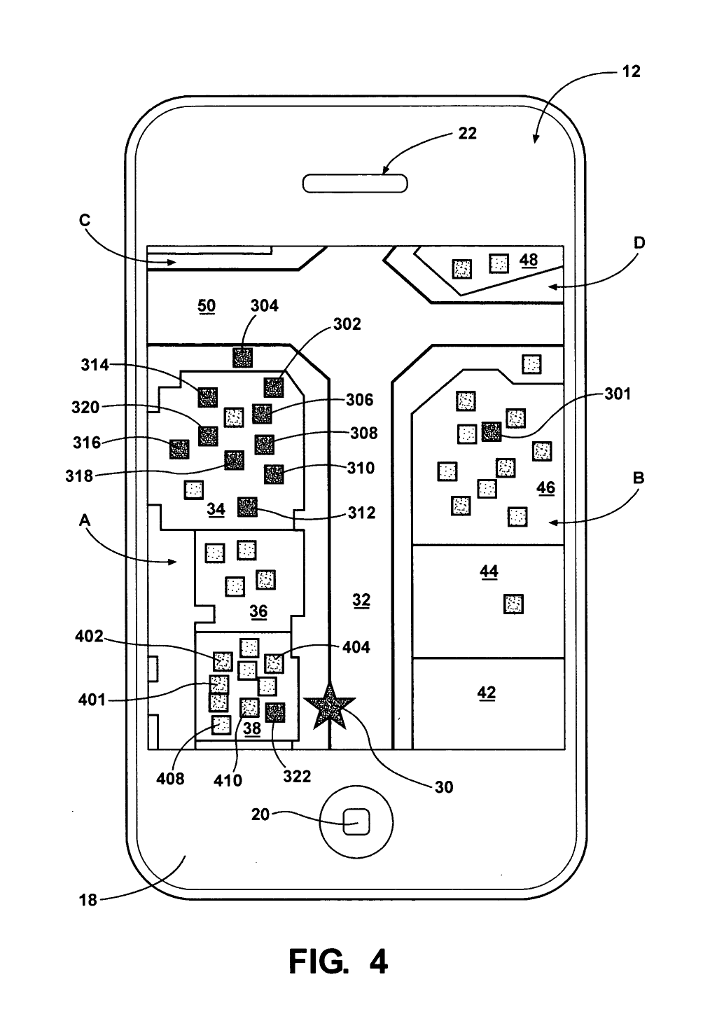

The system 10 disclosed herein enables existing social networks to be tailored to enhance communications in different social contexts and locations. A server or controller of the system 10 includes an information processor, a subscriber record data store, a communications system, a subscriber display manager, a subscriber input manager, a subscriber login manager, and a matching data manager. By way of illustration and without limiting the scope of the present invention, a computing device may be a standalone device such as a desktop computer or laptop computer, or it may be a communications device such as the cellular phone 12, a pager, a personal data assistant, a transponder, a radio, a walkie-talkie, or other mobile device that may communicate via network and without limiting the scope of the present invention. The computing device interacts with client via graphical user interface (GUI). As best shown in FIGS. 3 through 5, the computing device, such as the cellular phone 12 may utilize an input device such as a touch screen, generally indicated at 16 in FIGS. 3 and 4, a key pad 18, a pointing device (not illustrated), a thumbwheel 20, a voice recognition system or similar input mechanisms, generally indicated at 22.

The subscriber 14 communicates with a server via network. Network may be the Internet or it may be a limited access network such as a cable network or wireless network without limiting the scope of the present invention. The subscriber records data store have a program includes a subscriber profile for each subscriber associated with a subscriber identifier. The program includes a plurality of questions designed to receive characteristic data and preference data from the subscriber 14. The characteristic data may include and is not limited to age, marital status, physical size, physical limitations, religion, sexual orientation, how person feels, and similar personal information, weather person is romantic, rational, dreamer, etc. Preference data, for example, may include information relevant to establishing a business relationship such as for example, type of profession of a potential subscriber, type of business that the potential subscriber is engaged in, educational level of the potential subscriber, etc. Preference data may also include social relationship and information related questions to preferences of the potential subscriber. The potential subscriber will be asked questions about his/her preference in food, clothing, sports, entertainment, and music, and information that determines at least in part how the subscriber interacts with other subscribers. Subscriber profile data may be collected from a subscriber via a computer, a telephone, or via a personal interview.

The system 10 includes another program, i.e. identifier program of the system 10 for storing predetermined identifiers. Each identifier represents a certain type of the personality of the subscriber. For example, every subscriber who likes classical music, non spicy food, does like extreme sports but instead prefers playing chess and the like will be assigned or categorized as identifier type 1. Every subscriber who prefers spice food, extreme sports, and extreme fashion will be assigned or categorized as identifier type 2. The type of sports, foods, music separated by various identifiers is illustrated herewith for exemplary purposes only and is not intended to limit the scope of the present invention. Various other variations are available in the system. There are other types of identifiers available. For example, some subscribers may prefer spicy food and extreme sport but still enjoy to listed classical music.

The system 10 includes yet another program, i.e. color matching program. The color matching program is operatively communicated with the identifier program. The color matching program includes data with various color codes such as red, blue, yellow, pink, green, etc. There are numerous color codes presented in mixed colors. The color matching program is designed to assign a predetermined color code to the identifier type. For example, the subscriber 14 who likes spice food, extreme sports, and extreme fashion, i.e. the identifier type 2, will be assigned red color code. The color matching program and the identifier program of the system 10 are not limited to assigned particular color codes to particular identifier types. The system 10 may be changed to rearrange the colors and the identifier types between one another. New identifier types and color codes may be added to the system 10 or be preprogrammed in the system 10.

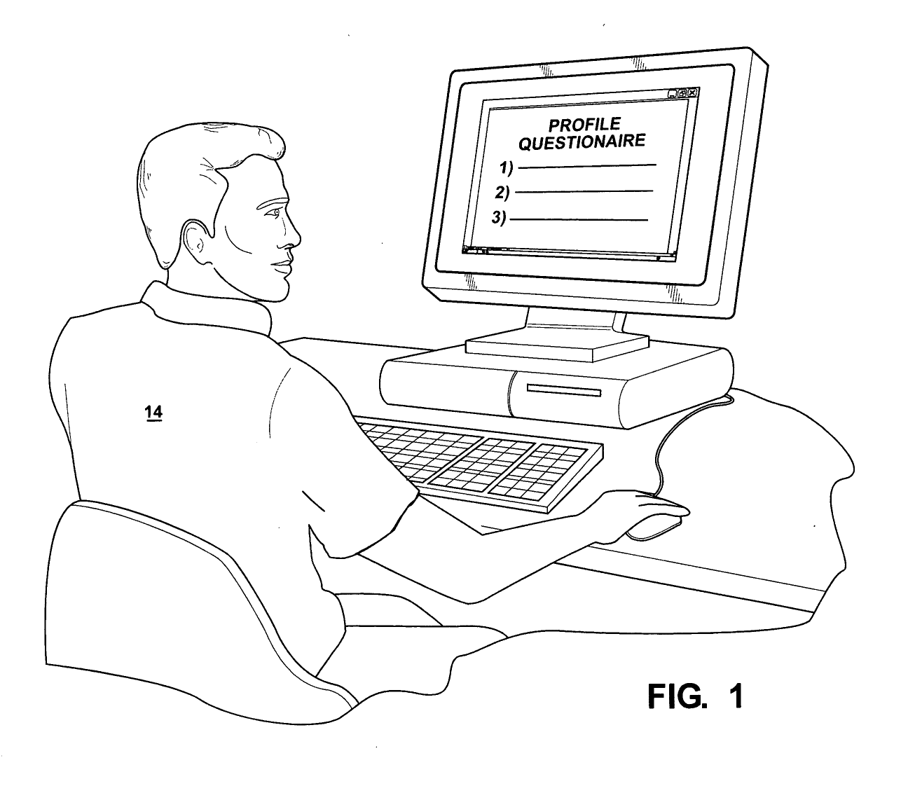

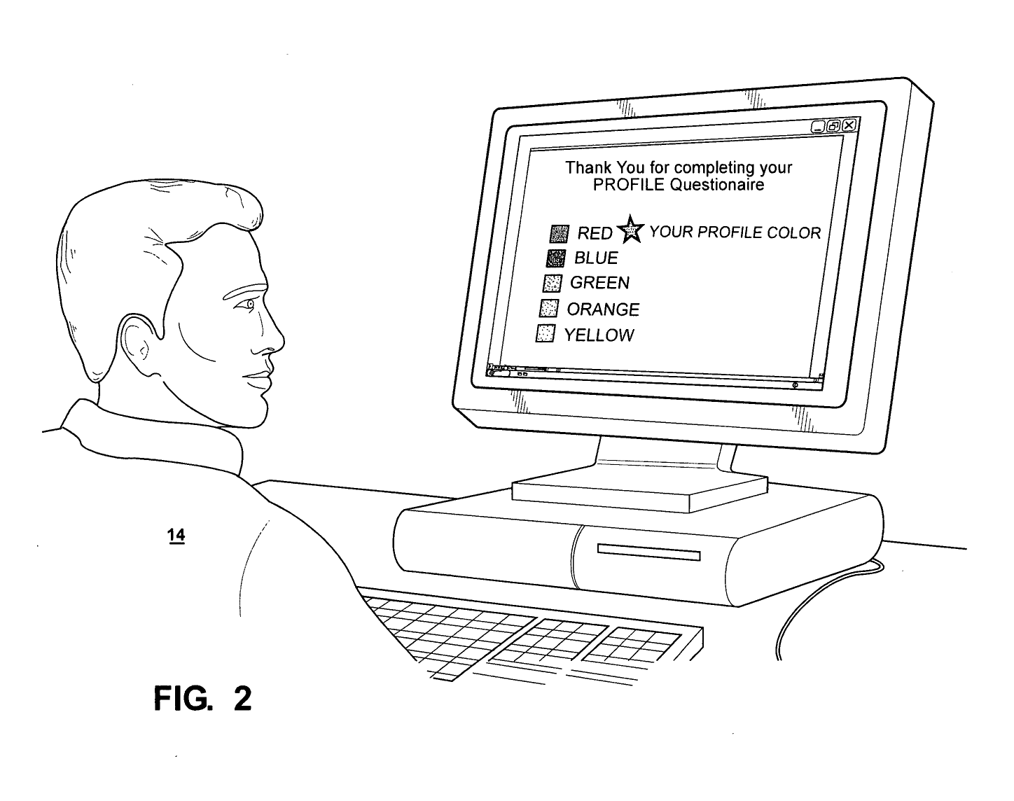

As illustrated in FIGS. 1 and 2, the process of subscribing begins with registration of the user on a website of the system as indicated at 20. The registration is not limited to the websites. FIGS. 1 and 2 show only one of the alternative embodiments of the present invention. The process of registering and subscribing to the system 10 may be initiated from the cellular phone 14. When the user or subscriber 14 is registered he/she will be asked a multitude of questions to determine the personality of the user, interests of the user, etc., as illustrated in FIG. 1. Based on the user type, a color code will be assigned to the subscriber 14 as best illustrated in FIG. 2.

As previously disclosed, for example, the subscriber 14 will be assigned red color if he/she likes hard rock music, extreme sports, piercing. FIG. 2 illustrates one of the embodiments of the present invention. The system 10 may not assign “color” to the user 14 wherein the user 14 will know his/her color. The system 10 will, however, assign the color code to the user 14 and will store the color code in the system 10. The user 14 will be provided with the option to either receive the color code and make his/her color code visible to other users or “hide” the color code from other thereby becoming invisible to other users.

If the subscriber 14 likes classical music, golf and reading books—green color will be assigned. Yellow color will be assigned to people who like pop music, baseball and movies. Mixed colors maybe used as well. Those skilled in the art will appreciate that the aforementioned colors are used for exemplary purposes without limiting the scope of the present invention. Many other colors such as grey, orange, pink, etc. may be used in application of the present invention without limiting the scope of the present invention.

If, for example, the subscriber 14 likes both hard rock music, extreme sports along with classical music, golf and reading books, he/she will be assigned a combined color code that may be presented as a mixed color (combination of green and red). The controller of the inventive system 10 is operatively communicated with Global Positioning System (GPS) and Google's map system or any other similar applications we will provide the users to virtually “check in” in any place in the city (restaurants, bars, shops, offices etc), depending to what type (color) of people, i.e. users go to certain places.

Referring now to FIG. 3, which illustrates a front view of the screen 16 of the cellular phone 12, a location of the subscriber 14 is shown by a star 30 at a particular street 32. A plurality of various establishments 34 through 48 are located along the street 32 and at intersection of that street 32 with other streets 50 and 52, wherein various sections, generally indicated at A through D, of the location are presented in different colors. For example, the section A is presented in red color, the section B presented in green color, the section C is presented in yellow color, and the section D is presented in blue color, as best illustrated in FIG. 3.

Referring back to FIG. 3, the inventive system may provide yet another alternative embodiment. When the user is subscribed to the system 10, he/she will be asked a multitude of questions to determine the personality of the user, interests of the user, etc., as illustrated in FIG. 1. Based on the user type, a color code will be assigned to the subscriber 14 without the user 14 being informed about the color. The system 10 will store the color code in the controller. The user 14 will be provided with the option to either receive the color code or make his/her color code visible to other users or “hide” the color code from other thereby becoming invisible to other users. The colors of a particular establishment, such as for example, the establishments 34 will change its color depending upon number of the users 13 sharing the same personality type, i.e. the identifiers and will be presented in the color of the majority identifiers located at the particular establishment and at the particular time. For example, if the establishment 34 is constantly visited by the users having so called “red” identifier and these users comprise a majority of visitors present at the particular establishment 34, the color of the establishment will always be “red”. However, the number and type of users 14 may be constantly changing. Therefore, the same establishment 34 may change its colors based on prevailing or majority number of personalities of the same type currently present at the establishment 34.

Alluding to the above, the statistical data will be calculated by the controller and the user 14 will be able to determine if percentage of personalities or various identifiers visited the establishment. For example, if the establishment 34 may be visited by the users 14 who have “green” color codes during the entire day or a month or a year more than the users having “red” color codes. Thus, the establishment 34 will be presented in “green” color. The user 14 will be able to see the “color” of the establishment on daily, monthly, or yearly bases. The user 14 may also be able to see the “color” of the establishment or any given locating by minutes without limiting the scope of the present invention. The user 14 will be able to determine how many times and home many “color” the particular location and or establishment changed during any given period of time to determine if the establishment 34 is suitable for activities preferred by certain group of users 14.

Alluding to the above, the section A of the street located on the left side relative the user 14, as shown in FIGS. 3 and 4 by the star 30, is presented in colors similar to the color assigned to the user, i.e. red color. As best illustrated in FIG. 4, the subscriber/user 14, also indicated at 30, is located near and between the establishments 40 and 42 with the establishments 38 and 34 on his/her left and the establishments 44 and 46 on his/her right side. The subscriber 14 may be either first time in the city looking to find a venue wherein other subscribers of the same type, shown at 302 through 322, i.e. those who like hard rock music, extreme sports, piercing, etc. are currently located.

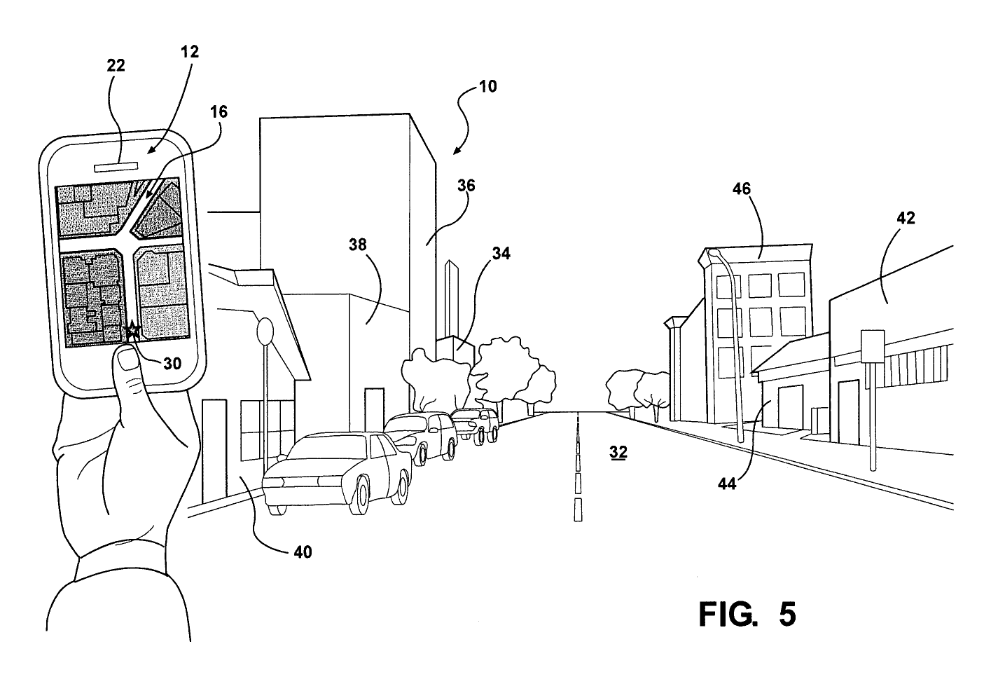

FIG. 5 shows a perspective view of the street 32 and a fragmental view of the user 14 holding the cellular phone 12 with the screen 16 indicated in FIG. 3. The subscriber 14 will see other subscribers of the system 10 who are currently located within the establishment. As best shown in FIG. 4, the establishment 34 has the most numbers of the subscribers that have the same personality type and the subscriber 14, i.e. red color. The establishment 40 has only one visitor who matches the “red” personality type. There is high likelihood that the establishment 34 can be a bar, a nightclub, which may attract people who like hard rock and spice food.

Alternatively, the establishment 34 may be an extreme fashion show or a store specializing in selling extreme cloth or shoes. Still as an alternative, the establishment 3 may be a sports palace wherein fans of extreme sports are gathered to socialize and meet each other. The establishment 34 may also be a movie theater that features a movie about a rock band or extreme sports. The establishment 34 may also be a venue that includes spice food restaurant, a shop to sell extreme cloth, and a shop that sell extreme sport good.

As shown in FIG. 4, the establishment 40, for example, has only one subscriber 322 who is “red”. All other subscribers 401 through 408, are recognized as the subscribers of another type, who may like classical music, non spicy food, etc. The subscriber 14 (shown at 30 in FIG. 4) has clear understanding that the establishment 34 has more subscribers sharing the same personality and interest as the subscriber 14. Without wasting time by going to Internet, or calling friends or relatives who live in the same place or had visited the place before, the user 14 determines the place that he/she would like to visit within seconds and without redundant operations, as set forth in other prior art application, which place he/she would like to visit.

Alternatively, the subscriber 14 may want to take a break and visit other places or try restaurants that serve non-spicy food or watch a movie totally unrelated to extreme sports theme. In this case, by using the system 10, the subscriber 14 will visit either the establishment 40 or 38. Each of the establishments may have more people that fit different personality profiles. The system 10 will present only those who subscribed to the system 10 and have their respective cellular phones or any other communications devices wherein the system's 10 software is downloaded thereby allowing creation of a geo-social network between all subscribers trying to search for places of interest. For example, the establishment 40, as shown in FIG. 4, has only one subscriber 322 who is “red”. This does not mean that there are no other people of the same type located therein. This means that there is only person who subscribed to the system 10 of the present invention.

The colors of these sections A through D and the establishments 34 through 48 will change depending upon time of the day, events being held at these places, etc. For example, if there is a rock band performance in American Airline Arena in Miami or at Times Square in New York—it probably will be shown as “red”, if it's a baseball event there—it's going to be yellow, if it's a classical even—the area will be “green”. If it's used as a hurricane shelter and all kind of people are in there—the place will be presented in shades/mix of all colors. The system 10 allows the subscriber to tap upon the establishment to use the option to determine if the selected establishment was “red” last week or will be “red” next week. The system 10 provides a unique marketing tool for anyone who wants to effectively advertise, market, and plan the business activities.

Referring back to FIG. 4, the establishment 42 may be a vacant lot or building or just a section in the building available for lease. Any potential tenant who will want to rent or purchase the vacant lot or the building will want to identify other venues located within proximity of the lot or the building. For example, the establishment 42 is located across from the establishment 40 and diagonally from the establishments 34 and 38 and adjacent to the establishment 44. The system 10 allows the person to identify the type of the establishment 34, 38, 44 by the type of crowd visiting the same and vent conduct statistical research of types of personalities who visited these establishments weeks, days, and years in the past or will visit the establishments in the future. The person may conduct the research of any particular place without being within proximity of the subject location and can do it at any given time simply by inserting the address of the location to identify the subject location by “colors”.

The system 10 is not limited in time frames wherein the subscriber can identify prior history of the venue such as what venue looked like weeks, months, years before or predict what the venue will look like weeks, months, years ahead. In addition, the subscriber 14 may determine the nature of the particular event that happened in the past. Places on the map as shown on the screen 16 of the cellular phone 12 in FIG. 4 or other communication devices (not shown) and map itself will change it is colors dynamically. The system 10 and method of the present invention provides the users 14 with unique and easy way to find places that people that think alike or share the same interests are coming to or to find people like them, etc. The radius of the venues in its relation to the user 14 can be expanded without limitations. The user 14 will be able to view all venues within 10 or 30 miles from the place where the user 14 is currently located. The user 14 may touch on any location on his/her screen to receive information such as hours of operation of the venue, menu, and the price for a ticket to attend the venue.

When the user 14 will register to use the inventive system 10, he/she will have an option to be viewable to other people who have the same interest and/or to view only places of interest, and or both. This feature will allow the user 14 who does not want to keep his/her interest in confidence but at the same time wants to know about venues and activities of the kind to make a choice whether to attend the same or not.

Alluding to the above, the system is easy to be used. The user may be located anywhere in the world. If, for example, the user is located on Madison Avenue, New York, the user may activate the system 10 on his/her cellular phone 12 or any other suitable data communication device. The system 10 will display all venues located within any selected radius from the place where the user is located, again as best shown in FIGS. 3 through 5. The user 14, assuming the user's color is “red” will select an option to view all venues located on Madison Avenue and within the pre-selected radius therefrom, wherein all hard rock music, extreme sports, piercing events take place at a particular time or took place days ago in the past or will take place in the future.

The user may create one or more functions after registering with the social networking server. A function is an input or automated query defined by the user from the communications device that calls a response from the social networking server or from an application residing on another communications device. For example, the user may use a function to determine the range for the localized geo-social network of the user, or as a query to the social networking server to find the best places to go for an evening based on the favorite venues of the user along with other determining criteria.

The users may create and use the functions, single or combined, to search for one or more locations and other geo-social networks with the most interesting or greatest number of friends and potential contacts. The user uses the functions to access and process data relating to a variety of social categories. The user may combine a series of search criteria to fine tune the searches, for example, by selecting context-specific preference profiles or selecting specific social groups. In response to a search, the user may receive ranked personal profiles of new contacts or potential members within the range of the registered geo-social network.

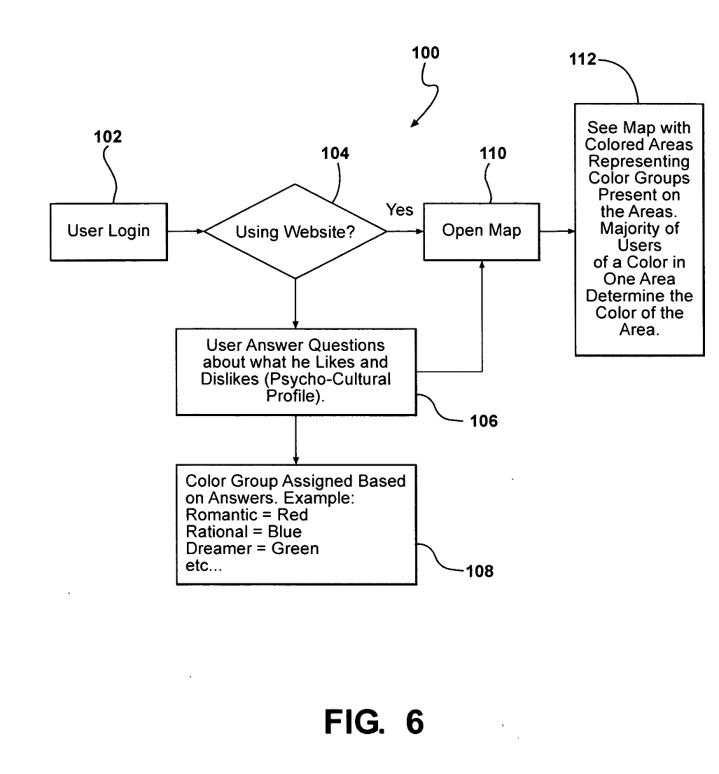

FIG. 6 illustrates yet another embodiment of the present invention generally shown at 100. The user logs in 102 into the system through a website 104. The user is asked number of various questions 106 to determine what the user likes and dislikes thereby creating psycho cultural profile of the user. The system includes numerous color codes assigned to different types of the users and based on the answers, as shown at 108. For example, “red” color code is assigned to the user who is “romantic”, “blue” color code is assigned to the user having rational behavior, a “dreamer” personality will be assigned “green” color code. Multiple color codes may be assigned to the users having split personalities. Numerous other personalities and color codes are used without limiting the scope of the present invention. After the user is assigned his/her color code, the user activated a map 110 to view numerous colored areas representing color groups present in the area, also shown in details in FIGS. 3 and 4. Majority of the users of the color code located in the area determines the color code of the area, as illustrated at 112.

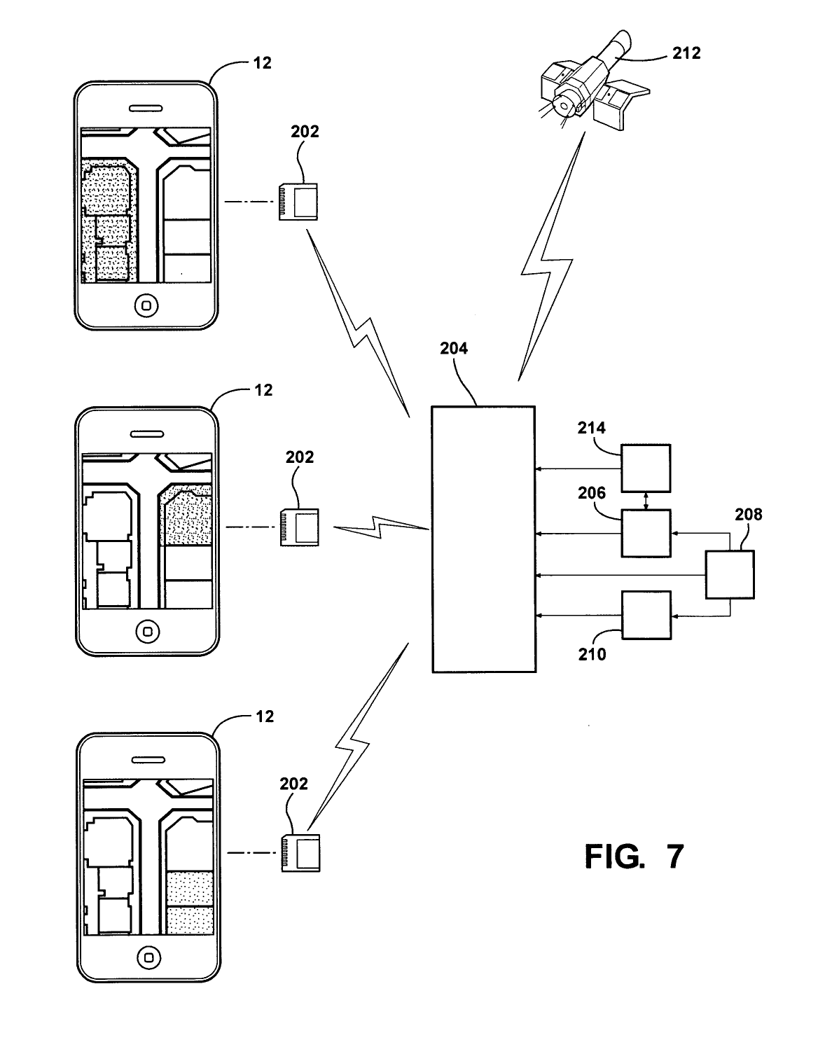

FIG. 7 illustrates a diagram of various components of the inventive system 10 operably communicating with one another to facilitate inventive method of identifying other users 14 and locations by colors. Each user of the system 10 has the cellular phone 12. Each cellular phone 12 has a chip 202 incorporated into the platform of the cellular phone 12. The chip 202 is wirelessly communicated with the controller 204 of the system 10. The controller included several components operably communicated with one another to facilitate the operational mode of the system 10.

A first block 206 includes a program storing a database of questions to be answered by the users to create personality profile of the users. A second block 214 stores multiple identifiers with each of the identifiers representing a type of the personality. Each identifier is matches with type of answers received from the user. A third block 210 has a program that assigns a color code to the identifier thereby identifying each user by the respective color to allow each user to locate other users positioned within area specified by the user. A third block 208 has a program adaptable to combine all users located within selected by the user location thereby separating the users by the identifiers and calculating number of all of the identifiers thereby exposing the location selected by the user in a color identified with the highest number of identifiers of the same type. The global positioning system 212 is operably communicated with the controller 204 to determine location of the user 14 subscribed to the system 10 and to present current location of the user 14 through the cellular phones 12 of other users 14.

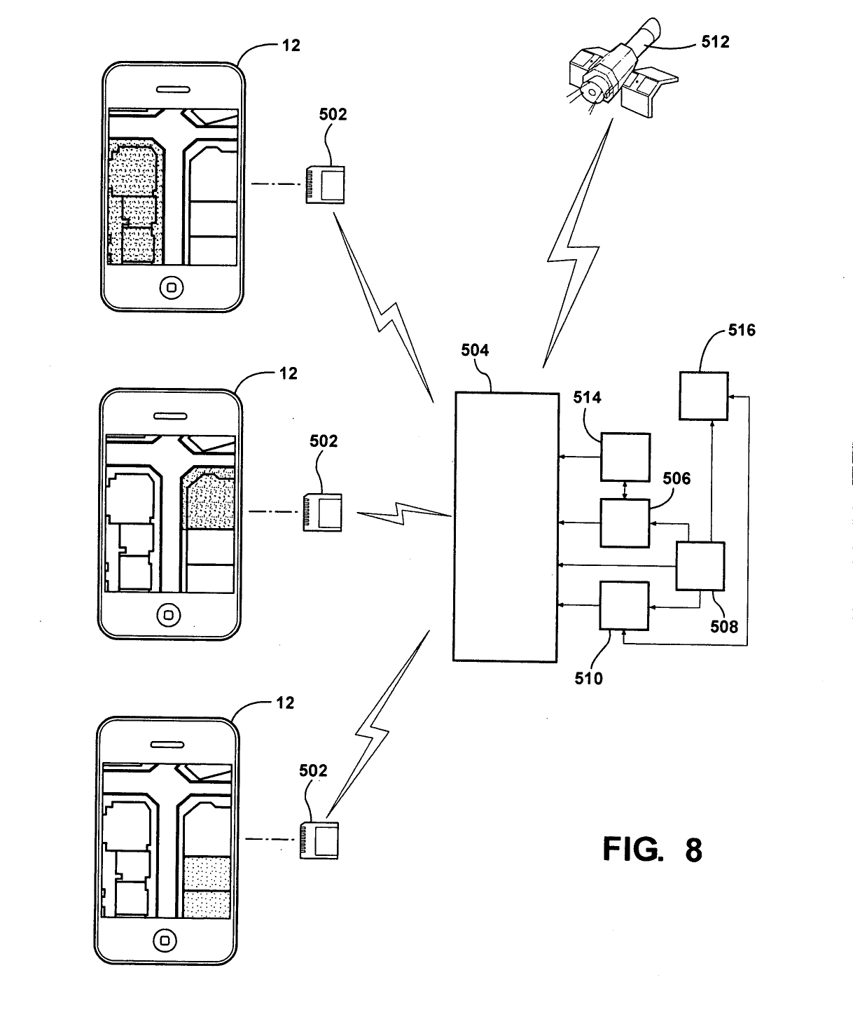

FIG. 8 illustrates yet another diagram of various components of the inventive system 10 operably communicating with one another to facilitate inventive method of identifying other users 14 and locations by colors. Each user of the system 10 has the cellular phone 12. Each cellular phone 12 has a chip 502 incorporated into the platform of the cellular phone 12. The chip 502 is wirelessly communicated with the controller 504 of the system 10. The controller included several components operably communicated with one another to facilitate the operational mode of the system 10.

A first block 506 includes a program storing a database of questions to be answered by the users to create personality profile of the users. A second block 514 stores multiple identifiers with each of the identifiers representing a type of the personality. Each identifier is matches with type of answers received from the user. A third block 510 has a program that assigns a color code to the identifier thereby identifying each user by the respective color to allow each user to locate other users positioned within area specified by the user.

A third block 508 has a program adaptable to combine all users located within selected by the user location thereby separating the users by the identifiers and calculating number of all of the identifiers thereby exposing the location selected by the user in a color identified with the highest number of identifiers of the same type. The global positioning system 512 is operably communicated with the controller 504 to determine location of the user 14 subscribed to the system 10 and to present current location of the user 14 through the cellular phones 12 of other users 14. A fourth block 516 has a separation program adaptable to combine answers of the users in response to the questions and to identify information contained in the answers wherein the information does not match to any of the identifiers. The separation program then generates new profiles whereby a new color code is assigned to the new profile from the third block 510 thereby increasing number of the predetermined identifiers and color codes to add more flexibility to the system 10.

The system 10 provides an improved method for location based dynamic social networking whereby the user 14 using his/her cell phone 12 may instantly identify a location, so called “hot spot” within a proximity to the person wherein other people sharing the same background, interest, hobbies, etc. are located at the present time or visited the location or even are planning to visit location in the future.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims

1. A system for providing social networking between users subscribing to said system from communication devices, said system comprising:
a controller having a database of questions to be answered by the users to create profile of each user and personality of each user;
a program of said controller adaptable to store identifiers with each of said identifiers representing a type of the personality;
a global positioning system operably communicated with said controller to determine location of the user subscribed to said system and present current location of the user through the communication device of other users; and
a second program of said system adaptable to assign a color to said identifier thereby identifying each user by the respective color to allow each user to locate other users positioned within area specified by the user.

2. A system as set forth in claim 1, wherein each of said colors represents at least one of said hobbies, interests, character type of the user.

3. A system as set forth in claim 1, wherein each of said colors represents combination of at least two colors whereby the user assigned said mixed color has at least two different personalities and has various hobbies and interest and shares at least two of said identifiers.

4. A system as set forth in claim 1, wherein said communication device includes at least one of a desktop computer, a laptop computer, a mobile phone, and a smart phone.

5. A system as set forth in claim 1, including a third program adaptable to combine all users located within selected by the user location thereby separating the users by said identifiers and calculating number of all of said identifiers thereby exposing the location selected by the user in a color identified with the highest number of identifiers of the same type.

6. A system as set forth in claim 1, wherein the users are connected with each other through said system by a network including at least one of a wired network, a wireless network, and a fiber network.

7. A system for providing social networking between users subscribing to said system from communication devices, said system comprising:
a controller of said system having a database of questions to be answered by users to create personality profile of the users with said controller adaptable to store predetermined identifiers representing a type of the personality of the user whereby a predetermined color is assigned to said predetermined identifier so that each user is identified by the color;
a global positioning system operably communicated with said controller to determine location of the user subscribed to said system and present current location of the user through said communication devices of the user; and
a program operably communicated with said controller to allow each user to locate other users positioned within selected area relative to the user thereby allowing the user to identify personalities of other users by respective colors and determine number of color of a location selected by the user as said program separates the users by said predetermined identifiers and presents the selected location in a color of the highest number of said predetermined identifiers of the same type.

8. A system as set forth in claim 7, wherein each of said colors represents at least one of said hobbies, interests, character type of the user.

9. A system as set forth in claim 7, wherein each of said colors presents combination of at least two colors whereby the user assigned said mixed color has at least two different personalities and has various hobbies and interest and shares at least two of said predetermined identifiers.

10. A system as set forth in claim 7, wherein said communication device includes at least one of a desktop computer, a laptop computer, a mobile phone, and a smart phone.

11. A system as set forth in claim 7, wherein the users are connected with each other through said system by a network including at least one of a wired network, a wireless network, and a fiber network.

12. A method of providing a system for social networking between users subscribing to the system from communication devices, said method comprising the steps of:
providing a controller having a database of questions to be answered by users to create personality profile of the user with the controller being networked with each user through the communication devices;
connecting a program to the controller adaptable for storing predetermined identifiers with each of the identifiers representing a type of the personality of the user;
connecting a global positioning system with the controller to determine location of the user subscribed to the system and to present current location of the user through the computing device of the user; and
connecting a second program to the system to assign a predetermined color to the predetermined identifier to allow each user to locate other users positioned within selected radius relative the user to identify personalities of other users.

13. A method as set forth in claim 12, wherein each of the colors represents at least one of said hobbies, interests, personality type of the user.

14. A method as set forth in claim 12, wherein each of the colors presents combination of at least two colors whereby the users assigned said mixed color has at least two different personalities and has various hobbies and interest and shares at least two of said identifiers.

15. A method as set forth in claim 14, wherein the communication device includes at least one of a desktop computer, a laptop computer, a mobile phone, and a smart phone.

16. A method as set forth in claim 15, including the step of connecting a third program to the controller wherein the third program is adaptable to combine all users located within selected by the user location to separate the users by personalities and calculating number of various personalities thereby exposing the location selected by the user in a color of the highest number of personalities of the same type.

17. (canceled)

18. (canceled)

19. (canceled)

20. (canceled)

21. (canceled)

22. (canceled)

23. (canceled)

24. (canceled)
